(19) United States
(12) Patent Application Publication
(10) Pub. No.: US 2025/0004816 A1
(43) Pub. Date: Jan. 2, 2025

(54) RATE LIMITING EVENTS IN A CONTAINER ORCHESTRATION SYSTEM

(71) Applicant: VMWARE, INC., Palo Alto, CA (US)

(72) Inventors: PALLA GOLLA DWARAKESH, Bangalore (IN); ANAND PRITAM, Bangalore (IN); VENU GOPALA RAO KOTHA, Bangalore (IN)

(21) Appl. No.: 18/376,852

(22) Filed: Oct. 5, 2023

(30) Foreign Application Priority Data
Jun. 30, 2023 (IN) 202341043949

(51) Int. Cl. G06F 9/455

(52) U.S. Cl. CPC G06F 9/45558

(57) ABSTRACT

An example method of managing events in a container orchestration (CO) system includes: receiving, at an event processor, a stream of events generated by the CO system, the events generated by worker nodes, control plane nodes, or both of the CO system; tracking, by the event processor, a rate of a plurality of the events in the stream received over a time period; indicating, by the event processor, that each of the plurality of events is non-skippable; determining, by the event processor for a first event in the stream of events after the plurality of events, that the rate exceeds a threshold limit over the time period; indicating, by the event processor, that the first event is skippable; and providing, by the event processor, each event in the stream of events indicated as being non-skippable to software for presentation to a user.

### RELATED APPLICATIONS

Benefit is claimed under 35 U.S.C. 119 (a)-(d) to Foreign application No. 202341043949 filed in India entitled “RATE LIMITING EVENTS IN A CONTAINER ORCHESTRATION SYSTEM”, on Jun. 30, 2023, by VMware, Inc., which is herein incorporated in its entirety by reference for all purposes.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pod” that execute on nodes in a cluster. Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

In a radio access network (RAN) deployment, such as a 5G RAN deployment, cell site network functions can be realized as Kubernetes pods. Each cell site can be deployed with one or more servers. Containerized network functions (CNFs) execute in the servers of the cell sites. The RAN can include several Kubernetes clusters spread across a plurality of disparate sites.

In container orchestration systems, such as Kubernetes, events are used to communicate information about the state of the system, including the status of resources, such as pods, nodes, and services. Events can be classified into several categories, such as normal, warning, and error categories. Normal events provide information about routine operations, such as successful pod creations, while warning events indicate potential issues, such as a pod running out of resources. Error events indicate problems that require immediate attention, such as a pod failing to start. A user of the RAN deployment can monitor events in the system. However, the RAN system can generate many events across the multiple Kubernetes clusters. Further, some events can be duplicates of other events. The event monitoring system and/or the user can become overwhelmed by the number of events to be processed. Further, the number of events and/or duplicate events can distract from the important events that should be acted upon, such as errors. It is desirable to process events generated by container orchestration systems in an efficient and non-redundant manner.

### SUMMARY

In an embodiment, a method of managing events in a container orchestration (CO) system is described. The method includes receiving, at an event processor, a stream of events generated by the CO system, the events generated by worker nodes, control plane nodes, or both of the CO system. The method includes tracking, by the event processor, a rate of a plurality of the events in the stream received over a time period. The method includes indicating, by the event processor, that each of the plurality of events is non-skippable. The method includes determining, by the event processor for a first event in the stream of events after the plurality of events, that the rate exceeds a threshold limit over the time period. The method includes indicating, by the event processor, that the first event is skippable. The method includes providing, by the event processor, each event in the stream of events indicated as being non-skippable to software for presentation to a user.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computing system in which embodiments described herein may be implemented.

FIG. 2 is a block diagram depicting a server of a site according to embodiments.

FIG. 3 is a block diagram depicting a container orchestration (CO) system according to embodiments.

FIG. 4 is a block diagram depicting logical data flow in a CO system according to embodiments.

FIG. 5 is a flow diagram depicting a method of processing events in a CO system according to embodiments.

FIG. 6 is a flow diagram depicting event processing in a CO system according to embodiments.

### DETAILED DESCRIPTION

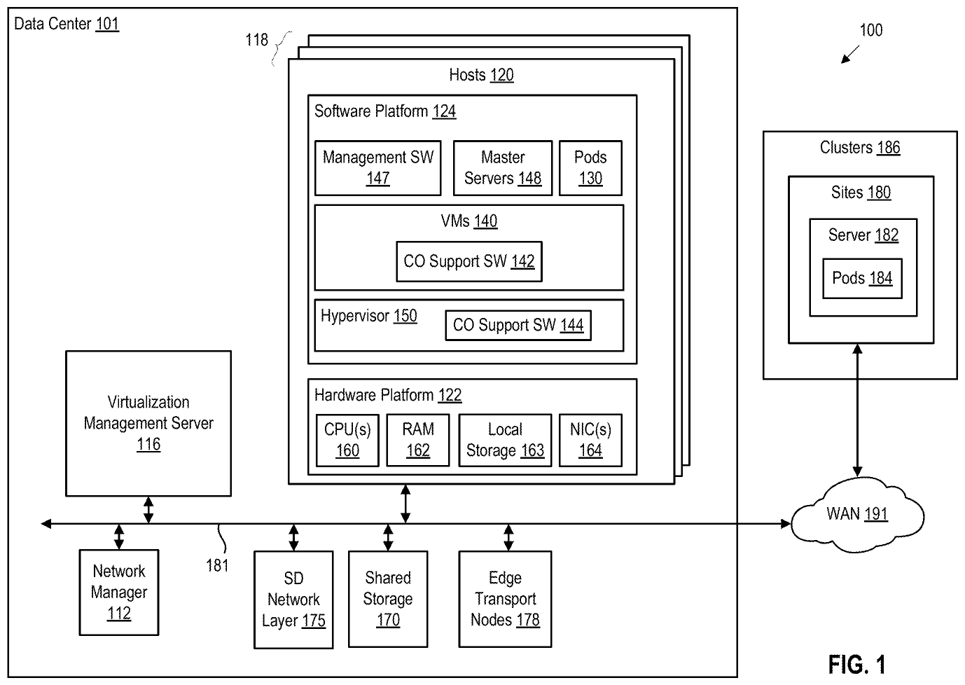

FIG. 1 is a block diagram of a virtualized computing system 100 in which embodiments described herein may be implemented. Virtualized computing system includes a data center 101 in communication with a plurality of sites 180 through a wide area network (WAN) 191 (e.g., the public Internet). Sites 180 can be geographical dispersed with respect to each other and with respect to data center 101. For example, sites 180 can be part of a radio access network (RAN) dispersed across a geographic region and serving different portions of such geographic region. Sites 180 can be organized into clusters 186, where each cluster 186 comprises a plurality of sites 180. In embodiments, data center 101 comprises a software-defined data center (SDDC) deployed in a cloud, such as a public cloud, private cloud, or multi-cloud system (e.g., a hybrid cloud system). In other embodiments, data center 101 can be deployed by itself outside of any cloud environment.

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

In embodiments, sites 180 perform software functions using containers. For example, in a RAN, sites 180 can include container network functions (CNFs) deployed as pods 184 by a container orchestrator (CO), such as Kubernetes. The CO control plane includes a master server 148 executing in host(s) 120. A master server 148 can execute in VM(s) 140 and includes various components, such as an application programming interface (API), database, controllers, and the like. A master server 148 is configured to deploy and manage pods 184 executing in sites 180. In some embodiments, a master server 148 can also deploy pods 130 on hosts 120 (e.g., in VMs 140). At least a portion of hosts 120 comprise a management cluster having master servers 148 and pods 130. Management software 147 can provide management functions for CO clusters, including creation, updating, and deletion of CO clusters. Management software 147 can communicate with control plane nodes and/or worker nodes of each CO cluster.

In embodiments, VMs 140 include CO support software 142 to support execution of pods 130. CO support software 142 can include, for example, a container runtime, a CO agent (e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubernetes control plane. For example, Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case. CO support software 144 can include a CO agent that cooperates with a master server 148 to deploy pods 130 in pod VMs of VMs 140.

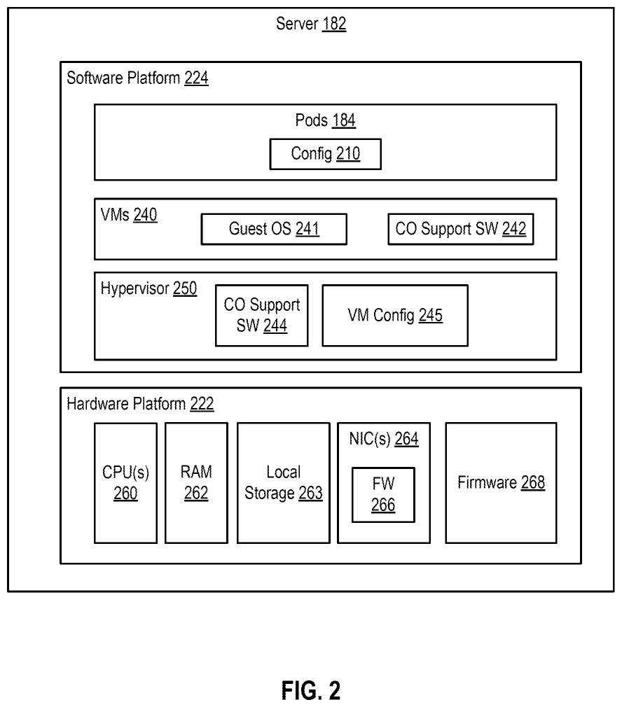

FIG. 2 is a block diagram depicting a server 182 of a site 180 according to embodiments. Server 182 may be constructed on a hardware platform such as an x86 architecture platform. As shown, a hardware platform 222 of server 182 includes conventional components of a computing device, such as one or more CPUs 260, system memory (e.g., RAM 262), one or more NICs 264, firmware 268 (e.g., BIOS or the like), and local storage 263. CPUs 260 are configured to execute instructions, for example, executable instructions that perform one or more operations described herein, which may be stored in RAM 262. NICs 264 enable server 182 to communicate with other devices (i.e., data center 101). In the example, NICs 264 have firmware 266.

A software platform 224 of server 182 includes a hypervisor 250, which directly executes on hardware platform 222. In an embodiment, there is no intervening software, such as a host OS, between hypervisor 250 and hardware platform 222. Thus, hypervisor 250 is a Type-1 hypervisor (also known as a “bare-metal” hypervisor). Hypervisor 150 supports multiple VMs 240, which may be concurrently instantiated and executed. Pods 184 execute in VMs 240 and have a configuration 210. For example, pods 184 can execute network functions (e.g., containerized network functions (CNFs)). In embodiments. VMs 240 include CO support software 242 and a guest operating system (OS) 241 to support execution of pods 184. CO support software 242 can include, for example, a container runtime, a CO agent (e.g., kubelet), and the like. Guest OS 241 can be any commercial operating system (e.g., Linux®). In some embodiments, hypervisor 250 can include CO support software 244 that functions as described above with hypervisor 150. Hypervisor 250 can maintain VM config data 245 for VMs 240.

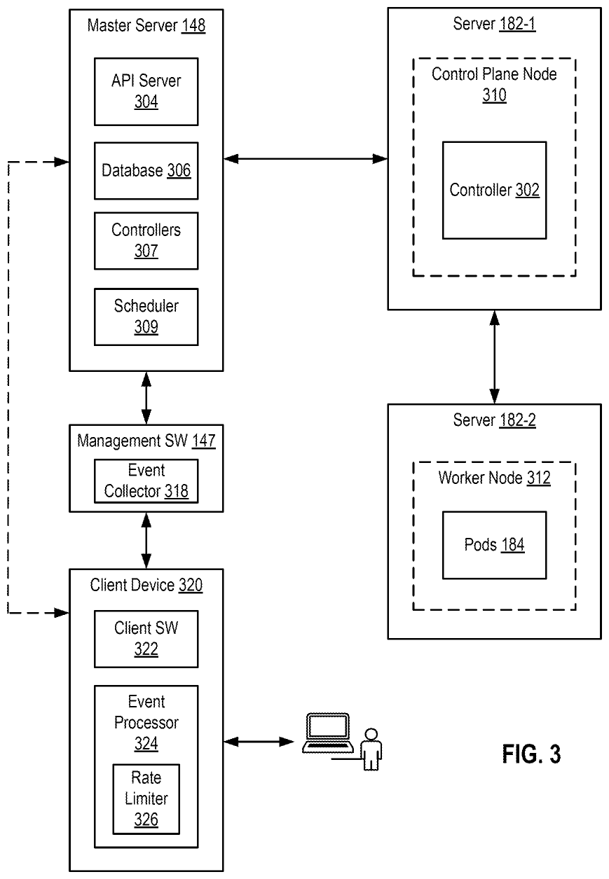

FIG. 3 is a block diagram depicting a container orchestration (CO) system according to embodiments. The CO system includes master server 148 and servers 182-1 and 182-2. In embodiments, master server 148 executes in data center 101 and servers 182-1 and 182-2 execute in sites 180. Master server 148 includes an application programming interface (API) server 304, a database 306, controllers 307, and a scheduler 309. A user or software interacts with API server 304 to define resources for the CO system, such as pods, deployments, services, and the like. The user or software specifies, through API server 304, states of the resources and the master server 148 executes workflows to apply and maintain the states.

Scheduler 309 watches database 306 for newly created pods with no assigned node. A pod is an object supported by API server 304 that is a group of one or more containers, with network and storage, and a specification on how to execute. Scheduler 309 selects candidate worker nodes for pods. Each controller 307 tracks objects in database 307 of at least one resource type. Controller(s) 307 are responsible for making the current state of a CO cluster come closer to the desired state as stored in database 306. A controller 307 can carry out action(s) by itself, send messages to API server 304 to have side effects, and/or interact with external systems. Controllers 307 manage default resources, such as pods, deployments, services, etc. (e.g., default Kubernetes controllers).

Pods are native objects of Kubernetes. The Kubernetes API can be extended with custom APIs to allow orchestration and management of custom objects referred to as custom resources (CRs). A custom resource definition (CRD) can be used to define CR to be handled by API server 304. Alternatively, an extension API server can be used to introduce a CR by API server aggregation, where the extension API server is fully responsible for the CR. A user interacts with custom APIs of API server 304 to create CRs tracked in database 306. A customer controller (e.g., controller 302) is used to watch for and actuate on CRs declared in database 306. Different custom controllers can be associated with different CRs. In Kubernetes, a controller responsible for the lifecycle of custom resources is referred to as an “operator.” However, the term controller will be used throughout this specification for consistency. In embodiments, a custom controller (controller 302) executes external to master server 148. In other embodiments, controller 302 can execute in master server 148.

In embodiments, controller 302 executes in a server 182-1 and monitors for CRs associated therewith. Server 182-1 can implement a control plane node 310 of the CO system. In embodiments, controller 302 monitors database 306 for CRs. In other embodiments, API server 304 notifies controller 302 of CRs. In the example, controller 302 is described as executing in a server 182-1 at a site 180. In other embodiments, controller 302 can execute in a host 120 of data center 101. In still other embodiments, controller 302 can execute in master server 148. Server 182-2 executes worker node 312, which includes pods 184. In general, a CO cluster includes control plane nodes 310 and worker nodes 312. A given server 182 can implement a control plane node, worker node, or both control plane and worker nodes. Master server 148 is an implementation of a control plane node, along with server(s) 182 that execute custom controllers. Worker nodes execute pods, which can include CNFs or the like.

The CO system generates events. Events can be generated by worker nodes 312 (e.g., from pods or software executing in pods), control plane nodes, or both. Events from control plane nodes 310 can be generated by custom controllers (controller 302) or from master server components (e.g., API server 304, controllers 308, scheduler 309, etc.). In embodiments, management software 147 includes an event collector 318 to collect events from control plane nodes and/or worker nodes. In some cases, worker nodes forward events to control plane nodes and thus event collector 318 can collect all events from control plane node(s). Each event indicates some activity that occurred in CO system. Events can include various parameters. Events can include classes, such as informational, warning, error, and the like.

In embodiments, a user interacts with a client device 320 executing client software 322. Client software 322 interacts with management software 147. Client device 320 can further include event processor 324. Event processor 324 receives a stream of events from event collector 318. The stream (“event stream”) includes the various events received by event collector from control plane/worker nodes in the CO system. In embodiments, CO system can include multiple clusters, each having its own set of control plane/worker nodes. Event collector 318 collects events from all clusters in CO system and provides an event stream to event processor 324 in client device 320.

Event processor 324 includes a rate limiter 326. Event processor 324 provides events in the event stream to client software 322 for presentation to the user. Event processor 324 only provides those events in the event stream indicated as being non-skippable. Rate limiter 326 processes events and can determine some events to be skippable. For example, as described further below, rate limiter 326 can track the rate of events in the event stream. If the rate exceeds a threshold rate over a threshold time period, rate limiter 326 can indicate subsequent events in the event stream as being skippable. After the threshold time period expires, rate limiter 326 indicates the events as being non-skippable and again tracks the rate and compares with the threshold rate over the threshold time. Each time rate limiter detects the rate of events over a threshold time period as exceeding the threshold rate, subsequent events are indicated as being skippable. The user can set the threshold rate and threshold time to control the amount of events presented. In embodiments, the user can further define a test for whether an event can be skipped that is first applied by rate limiter 326. For example, the user can specify that all error events are to be non-skippable. Thus, even if the rate of events in the event stream exceeds the threshold rate over the threshold time, rate limiter 326 will not mark error events (in this example) as being skippable. This allows the user to focus on more serious events without being flooded with too many events, duplicate events, and the like that obfuscate the more serious events.

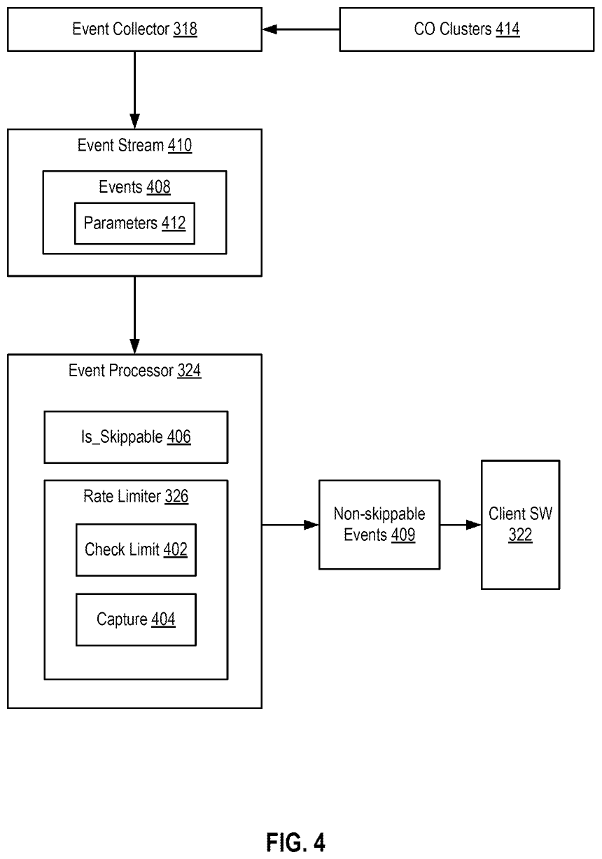

FIG. 4 is a block diagram depicting logical data flow in a CO system according to embodiments. In the example, CO clusters 414 comprising control plane nodes and worker nodes generate events, which are received by event collector 318. Event collector 318 generates an event stream 410 comprising events 408. Each event 408 includes a set of parameters 412, which can include a description of the event, time information, originating entity information, class information, and the like. Event processor 324 receives event stream 410. The user can define is_skippable 406. Is_skippable 406 comprises a routine that determines if an event is skippable or non-skippable and takes precedence over rate limiter 326. Thus, the user can configure is_skippable 406 to make all events classified as errors as non-skippable and all other events as skippable. Rate limiter 326 will apply rate-limiting on events except those designated as non-skippable by is_skippable 406.

Rate limiter 326 includes check limit 402 and capture 404 routines. Check limit 402 is configured to determine if the rate of event stream 410 during a threshold time period has exceeded a threshold rate. If check limit 402 returns true, rate limiter 326 applies rate limiting to event stream 410. Those events not specifically designated as non-skippable by is_skippable 406 are marked as skippable. If check limit 402 returns false, rate limiter 326 does not apply rate limiting and all events are marked non-skippable. Event processor 324 provides all non-skippable events 409 (those of events 408 marked non-skippable) in event stream 410 to client software 322. Capture 404 is configured update the rate tracking of rate limiter 326 as each event 408 in event stream 410 is processed. When check limit 402 returns false, event processor 324 executes capture 404 to perform rate tracking. When check limit 402 returns true, event processor 324 does not execute capture 404. Since rate tracking is performed over a threshold time period, when that time period ends, check limit 402 will again return false and rate tracking by capture 404 will resume.

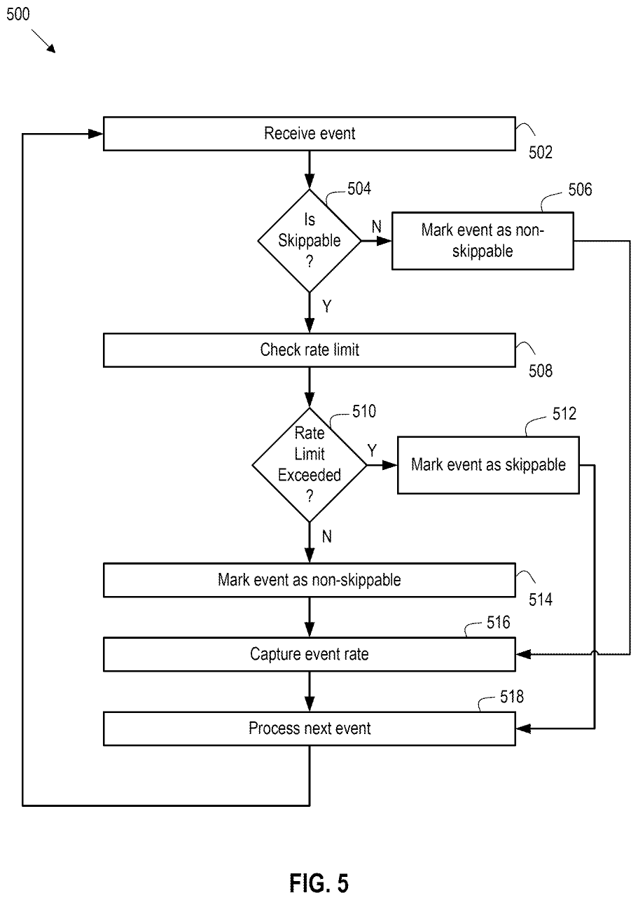

FIG. 5 is a flow diagram depicting a method 500 of processing events in a CO system according to embodiments. Method 500 begins at step 502, where event processor 324 receives an event of event stream 410. At step 504, event processor 324 determines if the event is skippable. For example, event processor 324 processes the event through is_skippable 406 in which the user defines criteria for marking some events as non-skippable and the rest as skippable. The user can use any parameter of the event in is_skippable 406, such as event message, event name, event class, and the like. If the event is not skippable at step 504, method 500 proceeds to step 506 and marks the event as non-skippable. Method 500 proceeds from step 506 to step 516.

If at step 504 the event can be skipped, method 500 proceeds to step 508. At step 508, event processor 324 checks the rate limit. As described above, rate limiter 326 tracks the rate of events in event stream over a time window. If the rate exceeds a rate threshold within the time window, check limit 402 returns true. Otherwise, check limit 402 returns false. Thus, at step 510, if the rate limit has been exceeded, method 500 proceeds to step 512 and marks the event as skippable. If the rate limit has not been exceeded, method 500 proceeds to step 514 and marks the event as non-skippable. Method 500 proceeds from step 512 to step 518.

At step 516, event processor 324 captures the current event rate. At step 518, event processor 324 processes the next event and returns to step 502.

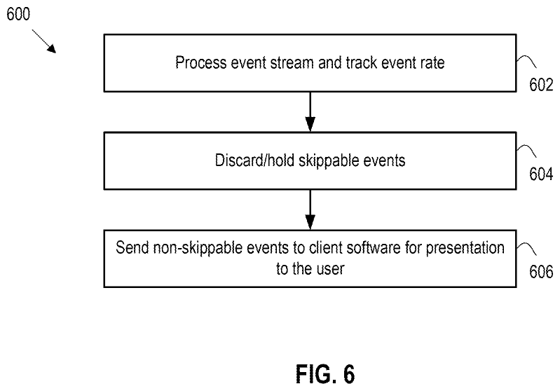

FIG. 6 is a flow diagram depicting event processing in a CO system according to embodiments. Method 600 begins at step 602, where event processor 324 processes the event stream and tracks the event rate as described above. Event processor 324 marks some events as non-skippable and other events as skippable as described above. At step 604, event processor 324 discards or holds all skippable events in the event stream. At step 606, event processor 324 sends non-skippable events to client software 322 for presentation to the user.

Event processing described above can be implemented using the following algorithm described in pseudocode.

slice_width=5

no_of_slices=6

limit=200

rate=new hash map with initial size as no_of_slices

getCurrentBucketId ( ) {

time_in_minutes=current_timestamp_in_minutes ( )
time_round=time_in_minutes % slice_width
return time_round}

update Rate (bucket_id) {

increment the count by 1 in the rate hash map for the given bucket_id}

cleanup (bucket_id) {

for each of the key in rate hash map:
If key <=bucket_id-(slice_width * no_of_slices):
Remove the key from the rate hash map}

getTotalEmitted ( ) {

return the sum of all values for all keys in the rate hash map}

checkLimit ( ) {

bucket_id=getCurrentBucketId ( )
cleanup (bucket_id)
total_emitted=getTotalEmitted ( )
if total_emitted >=limit return true
else return false}

capture ( ) {

bucket_id=getCurrentBucketId ( )
updateRate (bucket_id)
cleanup (bucket_id)}

The rate limiting algorithm described above in pseudocode can be used by the event consumer. The algorithm maintains a count of the events generated for a given period and also decides if an event has to be dropped based on the rate limit set by the consumer. In the algorithm, slice_width*number_of_slices determines the time window in terms of minutes. If slice_width is 5 and the number_of_slices is 6, then a 30 minute time window is provided. If in that 30 minute time window there are 200 events generated, the limit is reached. Any further events will be dropped. The decision to capture an event or not is up to the consumer, which can be decided based on their own criteria.

Below is an example pseudocode on how a consumer would consume the rate limiter algorithm. When an event occurs, the consumer would check if the event is skippable, is_skippable is a custom implementation on the consumer side, the consumer can use any parameter of the event to decide if they want to skip an event, parameters like event message, event name etc. are some examples.

On occurrence of a Kubernetes event:
If is_skippable (event):
If ratelimiter.checklimit ( ) is true:
skip the event
ratelimiter.capture ( )

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing events in a container orchestration (CO) system, comprising:
receiving, at an event processor, a stream of events generated by the CO system, the events generated by worker nodes, control plane nodes, or both of the CO system;
tracking, by the event processor, a rate of a plurality of the events in the stream received over a time period;
indicating, by the event processor, that each of the plurality of events is non-skippable;
determining, by the event processor for a first event in the stream of events after the plurality of events, that the rate exceeds a threshold limit over the time period;
indicating, by the event processor, that the first event is skippable; and
providing, by the event processor, each event in the stream of events indicated as being non-skippable to software for presentation to a user.

2. The method of claim 1, wherein the event processor executes in a client device in communication with management software executing in a data center, and wherein the management software receives the events and provides the stream of events to the client device.

3. The method of claim 1, wherein the event processor executes in a client device in communication with a control plane node of the CO system, and wherein the control plane node of the CO system provides the stream of events to the client device.

4. The method of claim 1, further comprising:
selecting, by the event processor, a second event in the stream of events after the first event;
determining, by the event processor, that a parameter of the second event matches criteria for a non-skippable event; and
indicating, by the event processor, that the second event is non-skippable despite the rate exceeding the threshold limit over the time period.

5. The method of claim 1, further comprising:
determining, by the event processor for a second event in the stream of events after the first event, that the rate does not exceed the threshold limit over the time period; and
indicating, by the event processor, that the second event is non-skippable.

6. The method of claim 1, wherein the CO system comprises a plurality of clusters disposed over a plurality of sites, each of the clusters comprising some of the worker nodes, some of the control plane nodes, or some of both, and wherein management software executing in a datacenter receives events generated by the plurality of clusters and provides the stream of events to the event processor.

7. The method of claim 6, wherein the control plane nodes of the CO system comprise at least one of controllers, schedulers, and application programming interface (API) servers, wherein the CO system comprises a data center and a plurality of sites, the event processor disposed in the data center, the worker nodes disposed in the plurality of sites, the worker nodes executing containerized network functions (CNFs).

8. A non-transitory computer readable medium comprising instructions to be executed in a computing device to cause the computing device to carry out a method of managing events in a container orchestration (CO) system, comprising:
receiving, at an event processor, a stream of events generated by the CO system, the events generated by worker nodes, control plane nodes, or both of the CO system;
tracking, by the event processor, a rate of a plurality of the events in the stream received over a time period;
indicating, by the event processor, that each of the plurality of events is non-skippable;
determining, by the event processor for a first event in the stream of events after the plurality of events, that the rate exceeds a threshold limit over the time period;
indicating, by the event processor, that the first event is skippable; and
providing, by the event processor, each event in the stream of events indicated as being non-skippable to software for presentation to a user.

9. The non-transitory computer readable medium of claim 8, wherein the event processor executes in a client device in communication with management software executing in a data center, and wherein the management software receives the events and provides the stream of events to the client device.

10. The non-transitory computer readable medium of claim 8, wherein the event processor executes in a client device in communication with a control plane node of the CO system, and wherein the control plane node of the CO system provides the stream of events to the client device.

11. The non-transitory computer readable medium of claim 8, further comprising:
selecting, by the event processor, a second event in the stream of events after the first event;
determining, by the event processor, that a parameter of the second event matches criteria for a non-skippable event; and
indicating, by the event processor, that the second event is non-skippable despite the rate exceeding the threshold limit over the time period.

12. The non-transitory computer readable medium of claim 8, further comprising:
determining, by the event processor for a second event in the stream of events after the first event, that the rate does not exceed the threshold limit over the time period; and
indicating, by the event processor, that the second event is non-skippable.

13. The non-transitory computer readable medium of claim 8, wherein the CO system comprises a plurality of clusters disposed over a plurality of sites, each of the clusters comprising some of the worker nodes, some of the control plane nodes, or some of both, and wherein management software executing in a datacenter receives events generated by the plurality of clusters and provides the stream of events to the event processor.

14. The non-transitory computer readable medium of claim 7, wherein the control plane nodes of the CO system comprise at least one of controllers, schedulers, and application programming interface (API) servers.

15. A computer system, comprising:
a hardware platform;
software, executing on the hardware platform, configured to:
receive, at an event processor, a stream of events generated by the CO system, the events generated by worker nodes, control plane nodes, or both of the CO system;
track, by the event processor, a rate of a plurality of the events in the stream received over a time period;
indicate, by the event processor, that each of the plurality of events is non-skippable;
determine, by the event processor for a first event in the stream of events after the plurality of events, that the rate exceeds a threshold limit over the time period;
indicate, by the event processor, that the first event is skippable; and
provide, by the event processor, each event in the stream of events indicated as being non-skippable to the software for presentation to a user.

16. The computer system of claim 15, wherein the event processor executes in a client device in communication with management software executing in a data center, and wherein the management software receives the events and provides the stream of events to the client device.

17. The computer system of claim 15, wherein the event processor executes in a client device in communication with a control plane node of the CO system, and wherein the control plane node of the CO system provides the stream of events to the client device.

18. The computer system of claim 15, wherein the software is configured to:
select, by the event processor, a second event in the stream of events after the first event;
determine, by the event processor, that a parameter of the second event matches criteria for a non-skippable event; and
indicate, by the event processor, that the second event is non-skippable despite the rate exceeding the threshold limit over the time period.

19. The computer system of claim 15, wherein the software is configured to:
determine, by the event processor for a second event in the stream of events after the first event, that the rate does not exceed the threshold limit over the time period; and
indicate, by the event processor, that the second event is non-skippable.

20. The computer system of claim 15, wherein the CO system comprises a plurality of clusters disposed over a plurality of sites, each of the clusters comprising some of the worker nodes, some of the control plane nodes, or some of both, and wherein management software executing in a datacenter receives events generated by the plurality of clusters and provides the stream of events to the event processor.
